(19) United States
(12) Patent Application Publication
(10) Pub. No.: US 2022/0289958 A1
(43) Pub. Date: Sep. 15, 2022

(54) ELASTOMER COMPOSITION FOR ACTUATOR, ACTUATOR MEMBER, AND ACTUATOR ELEMENT

(71) Applicants: ENEOS Corporation, Tokyo (JP); UNIVERSITY OF YAMANASHI, Kofu-shi, Yamanashi (JP)

(72) Inventors: Keisuke CHINO, Tokyo (JP); Hidenori OKUZAKI, Kofu (JP)

(73) Assignees: ENEOS Corporation, Tokyo (JP); UNIVERSITY OF YAMANASHI, Kofu-shi, Yamanashi (JP)

(21) Appl. No.: 17/638,107

(22) PCT Filed: May 27, 2020
(86) PCT No.: PCT/JP2020/020838

§ 371 Date: Feb. 24, 2022

(30) Foreign Application Priority Data
Aug. 29, 2019 (JP) 2019-157196

(51) Int. Cl. C08L 23/16; C08L 23/08; C08L 23/20; F03G 7/06

(52) U.S. Cl. CPC C08L 23/16; C08L 23/08; C08L 23/20; F03G 7/06

(57) ABSTRACT

Disclosed is an elastomer composition for an actuator that can be operated by changing only the amount of heat energy. The elastomer composition has an entropy elastic modulus of 3.0 kPa/K or more and comprises a polymer comprising at least a structural unit derived from ethylene. The polymer can be a synthetic rubber.

### BACKGROUND OF THE INVENTION

### Field of the Invention

The present invention relates to an elastomer composition for an actuator, and more particularly to an elastomer composition for use in an actuator that can be operated only by changing the amount of heat energy. The present invention also relates to an actuator member using the elastomer composition for an actuator, and an actuator element provided with the actuator member.

### Background Art

A conventionally known actuator is one operated by external stimulation. For example, a method has been proposed in which a polymer film or fiber is stretched or bent by absorption and desorption of water molecules by electrical stimulation (see Patent Documents 1 and 2). In such a method, the contraction rate of the polymer film itself was less than 5%. In order to increase the contraction rate, the relative humidity had to be adjusted within the range of 80% to 100%. Therefore, there has been a problem that the operation of the actuator is not stabilized depending on the environmental (atmospheric) conditions in which the polymer film is provided.

Therefore, there is a need to obtain a high contraction rate and to exhibit good actuator performance (work density) according to the conditions of external stimulation without being influenced by environmental conditions such as humidity.

### PRIOR ART DOCUMENTS

### Patent Documents

Patent Document 1: WO2006/025399
Patent Document 2: WO2008/055041

### SUMMARY OF THE INVENTION

### Problem to be Solved by the Invention

Until now, there has been no known actuator that can be operated only by changing the amount of heat energy using entropy elasticity instead of electrical stimulation an external stimulation. As a result of intensive research, the present inventors have found that an actuator that can be operated only by changing the amount of heat energy can be obtained by using an elastomer composition having an entropy elastic modulus equal to or greater than a specific value and containing a polymer including at least a structural unit derived from ethylene, thereby completing the present invention.

That is, according to the present invention, the following inventions are provided.

[1] An elastomer composition for use in an actuator that can be operated only by changing the amount of heat energy, wherein the elastomer composition for an actuator has an entropy elastic modulus of 3.0 kPa/K or more and comprises a polymer comprising at least a structural unit derived from ethylene.
[2] The elastomer composition for an actuator according to [1], wherein the polymer is a synthetic rubber comprising at least a structural unit derived from ethylene.
[3] The elastomer composition for an actuator according to [2], wherein the polymer is at least one selected from the group consisting of ethylene propylene rubber, ethylene butene rubber, ethylene octene rubber, ethylene propylene diene rubber, ethylene butene diene rubber, and ethylene octene diene rubber.
[4] The elastomer composition for an actuator according to any one of [1] to [3], wherein the ethylene content in the polymer is 45% by mass or more.
[5] The elastomer composition for an actuator according to any one of [1] to [4], wherein the polymer is cross-linked by using a cross-linking agent.
[6] The elastomer composition for an actuator according to [5], wherein the cross-linking agent is a peroxide-based cross-linking agent or a sulfur-based cross-linking agent.
[7] An actuator member formed of the elastomer composition for an actuator according to any one of [1] to [6].
[8] The actuator member according to [7], wherein the actuator member is in the form of a film, a sheet, a plate, or a rod.
[9] An actuator element comprising the actuator member according to [7] or [8], and a heater layer.
[10] The actuator element according to [9], wherein the heater layer is comprised of a heating element.
[11] The actuator element according to [10], wherein the heating element is comprised of a resistant heating element using Joule heat.
[12] The actuator element according to any one of [9] to [11], wherein the actuator element further comprises a thermally conductive layer between the actuator member and the heater layer.
[13] The actuator element according to [12], wherein the thermally conductive layer is comprised of a heat radiating material.

### Effect of the Invention

According to the present invention, it is possible to provide an elastomer composition for an actuator that can be operated only by changing the amount of heat energy. According to the present invention, it is also possible to provide an actuator member which can exhibit good actuator performance (work density), and an actuator element provided with the actuator member.

### BRIEF DESCRIPTION OF THE DRAWINGS

FIG. 1 is a schematic diagram showing an actuator element (when stretched) according to one embodiment of the invention.

FIG. 2 is a schematic diagram showing an actuator element (when contracted) according to one embodiment of the invention.

### MODE FOR CARRYING OUT THE INVENTION

### [Elastomer Composition]

The elastomer composition of the present invention is to be used for an actuator that can be operated only by changing the amount of heat energy. Such an actuator can be operated stably only by changing the amount of heat energy without being affected by environmental conditions such as humidity.

The elastomer composition has an entropy elastic modulus of 3.0 kPa/K or more, preferably 3.2 kPa/K or more, more preferably 3.5 kPa/K or more, and even more preferably 4.0 kPa/K or more. The entropy elastic modulus can be appropriately adjusted by changing the types of the following polymers and the types and amounts of additives such as a cross-linking agent and a cross-linking aid.

The entropy elastic modulus of the elastomer composition in the present invention can be measured as follows.

Tension F when an elastomer composition is elongated is expressed by a Kelvin equation, where the first term represents energy elasticity due to internal energy (f_{U}) and the second term represents entropy elasticity due to entropy (f_{S}). That is, the entropy elasticity depends on temperature (T), and its gradient (∂F/∂T) is an important parameter as the entropy elastic modulus.

$$F = {( \frac{\partial U}{\partial L} )}_{p , T} - {T ( \frac{\partial S}{\partial L} )}_{p , T} = {( \frac{\partial U}{\partial L} )}_{p , T} + {T ( \frac{\partial F}{\partial T} )}_{p , L}$$

In a stretched state, stress in the elastomer composition increases with increasing temperature, and the appearance of the entropy elasticity can be confirmed. The gradient at this time becomes the entropy elastic modulus.

### (Polymer)

The elastomer composition comprises a polymer comprising at least a structural unit derived from ethylene. The polymer is preferably a synthetic rubber containing at least a structural unit derived from ethylene, and it may contain at least one structural unit derived from propylene, butene, octene, or a diene monomer in addition to the structural unit derived from ethylene. Examples of such polymers include ethylene propylene rubber (EPM), ethylene butene rubber (EBM), ethylene octene rubber, ethylene propylene diene rubber (EPDM), ethylene butene diene rubber, and ethylene octene diene rubber. Among these, ethylene propylene diene rubber (EPDM) is preferable to use in order to increase the entropy elastic modulus.

The ethylene content in the polymer is preferably 45% by mass or more, more preferably 50% by mass or more, and still more preferably 60% by mass or more. When the ethylene content in the polymer is equal to or greater than the above-mentioned value, the crystallinity of the polymer increases, a high contraction rate can be obtained due to a change in the amount of heat energy, and good actuator performance (work density) can be exhibited.

Without being bound to theory, containing at least a structural unit derived from ethylene as a structural unit of the polymer can be a physical cross-linking point. Therefore, molecular motion between the cross-linking points is activated by heating to generate large contraction stress, and as a result, the entropy elastic modulus can be increased. In particular, when the ethylene content in the polymer is 50% by mass or more, a larger contraction stress is generated, and as a result, the entropy elastic modulus can be increased more.

In the present invention, the elastomer composition has an entropy elastic modulus of 3.0 kPa/K or more and by containing the above-mentioned polymer, the actuator performance (work density) can be improved.

### (Cross-Linking Agent)

The elastomer composition is preferably cross-linked by using a cross-linking agent for cross-linking the polymer. As the cross-linking agent, a peroxide-based or a sulfur-based cross-linking agent can be used. Examples of the peroxide-based cross-linking agent include peroxyketals such as 1,1-di(t-butylperoxy)cyclohexane (PHC), dialkyl peroxides such as dicumyl peroxide (DCP), 2,5-dimethyl-2,5-di(t-butylperoxy)hexane (HXA), 2,5-dimethyl-2,5-di(t-butylperoxy)hexene-3 (HXY), diacyl peroxides such as dibenzoyl peroxide (BPO), and peroxyesters such as t-butylperoxybenzoate. Examples of the sulfur-based cross-linking agent include powdered sulfur, precipitated sulfur, highly dispersed sulfur, surface treated sulfur, insoluble sulfur, dimorpholin disulfide, and alkylphenol disulfide.

The amount of the cross-linking agent added can be appropriately set according to the type of polymer and the type of cross-linking agent, and may be an amount sufficient to cross-link the polymer so that the entropy elastic modulus of the elastomer composition is 3.0 kPa/K or more. For example, when a peroxide-based cross-linking agent is used, the amount of the peroxide-based cross-linking agent added is preferably 1 to 25 parts by mass and more preferably 3 to 20 parts by mass with respect to 100 parts by mass of the polymer. In addition, when a sulfur-based cross-linking agent is used, the amount of the sulfur-based cross-linking agent added is preferably 0.8 to 10 parts by mass and more preferably 1 to 5 parts by mass with respect to 100 parts by mass of the polymer.

### (Other Additives)

The elastomer composition may contain other additives such as a silane coupling agent, vulcanization accelerator, vulcanization accelerator aid, cross-linking aid, anti-aging agent, antioxidant, and colorant in addition to the above-mentioned polymer and cross-linking agent to the extent that the actuator performance is not impaired.

Examples of the vulcanization accelerator include thiuram-based such as tetramethylthiuram disulfide (TMTD), tetraethylthiuram disulfide (TETD) and tetramethylthiuram monosulfide (TMTM), aldehyde/ammonia-based such as hexamethylenetetramine, guanidine-based such as diphenylguanidine (DPG), thiazole-based such as 2-mercaptobenzothiazole (MBT) and dibenzothiazyl disulfide (DM), sulfenamide-based such as N-cyclohexyl-2-benzothiazylsulfideamide (CBS) and N-t-butyl-2-benzothiazylsulpheneamide (BBS), and dithiocarbamate-based such as zinc dimethyldithiocarbamate (ZnPDC). The amount of vulcanization accelerator blended is preferably 0.1 to 10 parts by mass, and more preferably 1 to 5 parts by mass, based on 100 parts by mass of the polymer.

Examples of the vulcanization accelerator aid include fatty acids such as acetyl acid, propionic acid, butanoic acid, stearic acid, acrylic acid, and maleic acid; fatty acid zinc such as zinc acetylate, zinc propionate, zinc butanoate, zinc stearate, zinc acrylate, and zinc maleate; and zinc oxide. The amount of vulcanization accelerator aid blended is preferably from 0.1 to 10 parts by mass, and more preferably from 1 to 5 parts by mass, based on 100 parts by mass of the polymer.

Examples of the cross-linking aid include triallyl isocyanurate (TAIC), triallyl cyanurate (TAC), (m-, p-, o-)phenylene bismaleimide, quinonedioxime, 1,2-polybutadiene, diallyl phthalate, ethylene glycol dimethacrylate, trimethylolpropane trimethacrylate, triethylene glycol dimethacrylate and the like. The amount of cross-linking aid blended is preferably from 0.1 to 20 parts by mass, and more preferably from 1 to 10 parts by mass, based on 100 parts by mass of the polymer.

Examples of the anti-aging agent include compounds such as aliphatic and aromatic hindered amines and hindered phenols. The amount of anti-aging agent blended is preferably from 0.1 to 10 parts by mass, and more preferably from 0.3 to 5 parts by mass, based on 100 parts by mass of the polymer.

Examples of the antioxidant include butyl hydroxytoluene (BHT), butyl hydroxyanisole (BHA) and the like. The amount of antioxidant blended is preferably from 0.1 to 10 parts by mass, more preferably from 0.3 to 5 parts by mass, based on 100 parts by mass of the polymer.

Examples of the colorant include inorganic pigments such as titanium dioxide, ultramarine blue, bengal, lithopone, lead, cadmium, iron, cobalt, aluminum, hydrochloride and sulfate, azo pigments, copper phthalocyanine pigments and the like. The amount of coloring agent blended is preferably from 0.1 to 10 parts by mass, and more preferably from 0.3 to 5 parts by mass, based on 100 parts by mass of the polymer.

### [Actuator Member]

The actuator member of the present invention is obtained by molding the above-mentioned elastomer composition, and it stretches and contracts in the length direction (longitudinal direction) only by a change in the amount of heat energy. In particular, the actuator member of the present invention can contract by applying heat energy in a state of being applied with a constant load.

The shape and size of the actuator member are not particularly limited, which can be appropriately selected according to the application of the actuator element. The shape of the actuator member may be, for example, a film shape, a sheet shape, a plate shape, or a rod shape. The size of the actuator member is, for example, 1 to 1000 mm and preferably 10 to 500 mm in length, 1 to 1000 mm and preferably 5 to 500 mm in width, 1 μm to 100 mm and preferably 10 μm to 10 mm in thickness.

### [Actuator Element]

The actuator element of the present invention comprises the above-mentioned actuator member and a heater layer. The actuator element may further comprise a thermally conductive layer between the actuator member and the heater layer. By applying heat energy to the actuator member by the heater layer, the actuator member can contract in the length direction (longitudinal direction).

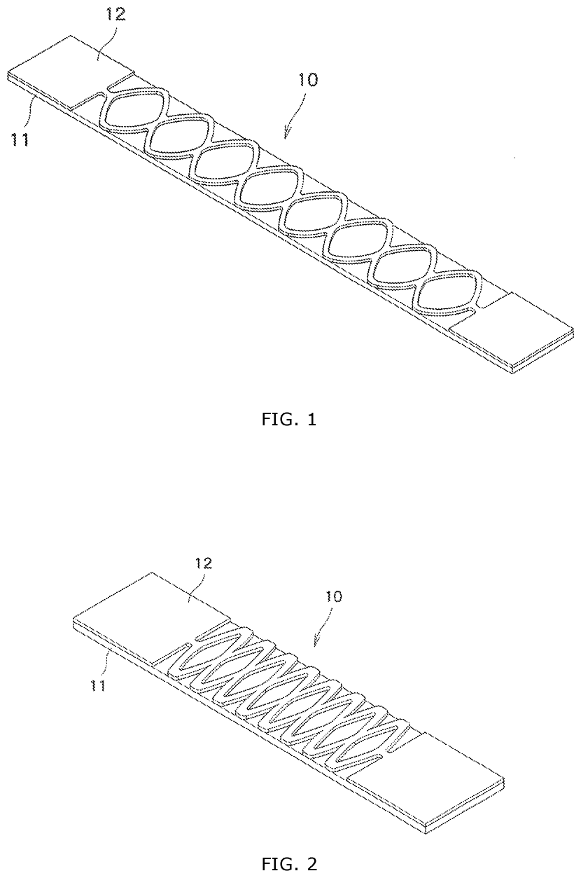

Schematic diagrams of an actuator element according to one embodiment of the present invention are shown in FIGS. 1 and 2. The actuator element 10 shown in FIGS. 1 and 2 is provided with an actuator member 11 and a heater layer 12 on the actuator member 11. The central portion of the heater layer 12 is processed into a mesh shape so as to easily follow the stretching and contraction of the actuator member. FIG. 1 shows the actuator element at the time of stretching, and FIG. 2 shows the actuator element at the time of contraction.

The actuator element of the present invention can be used for various applications. Examples include belts such as a smartwatch, clock, and pedometer; artificial muscles; and a drive portion in an endoscope.

### (Heater Layer)

The heater layer is not particularly limited as long as it is capable of applying heat energy to the actuator member, but is made of, for example, a heating element, preferably a resistant heating element using Joule heat. As for the resistant heating element, any known heating element can be used without particular limitation, where examples thereof being metals such as copper and nichrome (nickel-chrome alloy), nonmetals such as carbon and silicon carbide, conductive polymers, etc., and among these, a conductive polymer film is preferably used from the viewpoint of workability and stretchability. Although the shape of the resistant heating element is not particularly limited, it can be processed so as to easily follow the elongation and contraction of the actuator member and be used. The heater layer may be laminated on the entire surface or only one portion of the actuator member.

The conductive polymer film used as the heater layer is a film containing at least a conductive polymer. Examples of the conductive polymer include at least one selected from polythiophene, polypyrrole, polyaniline, polyacetylene, polydiacetylene, polyphenylene, polyfuran, polyselenophene, polytellurophene, polyisothianaphthene, polyphenylene sulfide, polyphenylene vinylene, polythieneylenevinylene, polynaphthalene, polyanthracene, polypyrene, polyazulene, polyfluorene, polypyridine, polyquinoline, polyquinoxaline, polyethylenedioxythiophene, and derivatives thereof.

The conductive polymer film may further contain a neutral polymer or a polymer electrolyte. Examples of the neutral polymer include at least one selected from cellulose, cellophane, nylon, polyvinyl alcohol, vinylon, polyoxymethylene, polyglycerin, polyethylene glycol, polypropylene glycol, polyvinyl pyrrolidone, polyvinyl phenol, poly 2-hydroxyethyl methacrylate, and derivatives thereof. Examples of the polymer electrolyte include at least one selected from polycarboxylic acids such as polyacrylic acid and polymethacrylic acid, polysulfonic acids such as polystyrene sulfonic acid, poly2-acrylamide-2-methylpropane sulfonic acid and Nafion, polyamines such as polyallylamine, polydimethylpropyl acrylamide, and quaternary salts and derivatives thereof.

The conductive polymer film can be produced by applying to the conductive polymer at least one technique selected from casting, bar coating, spin coating, spraying, electrolytic polymerization, chemical oxidation polymerization, melt spinning, wet spinning, solid phase extrusion, and electro-spinning. Particularly preferred is a conductive polymer film of poly(3,4-ethylenedioxythiophene) doped with poly(4-styrenesulfonic acid), which provides high electrical conductivity. It is also preferred that polyglycerin is blended as a neutral polymer to the conductive polymer film.

### (Thermally Conductive Layer)

The thermally conductive layer is a layer for efficiently transmitting the heat energy of the heater layer to the actuator member. It is preferable that the thermally conductive layer is a layer made of a heat radiating material. For example, a heat radiating grease may be used as the heat radiating material. A heat radiating grease is obtained by using a base oil of mineral oil or synthetic oil, adding a thickener such as soap or else thereto, and further adding a conductive material such as carbon black. Examples of the synthetic oil include a diester oil, a polyol ester oil, and a polyalkylene glycol oil. It is also possible to facilitate sliding between the actuator member and the heater layer by using the heat radiation grease.

### EXAMPLES

The present invention will be specifically described below with reference to the Examples and Comparative Examples, but the present invention shall not be limited by these Examples.

### Test Example 1

### Example 1

The following components were each kneaded using a 100 mL kneader (Laboplast Mill manufactured by Toyo Seiki Co., Ltd.) to obtain an elastomer composition. The details of the kneading operation are as shown in (i) to (ii) below.

(i) Mixer kneading: Rubber was charged into a closed pressure kneader heated to 120° C., and after mastication was performed at 30 rpm for 1 minute, half of the amount of a mixture measured of zinc oxide, stearic acid and an anti-aging agent was charged, and the rotational speed was raised to 50 rpm, and kneading was performed for 1 minute and 30 seconds. Then, the remaining half of the amount of the mixture of zinc oxide, stearic acid and an anti-aging agent was added, and kneading was continued for 1 minute and 30 seconds. After that, ram (floating weight) was raised, and the powder of the mixture of zinc oxide, stearic acid and an anti-aging agent adhered to the surrounding was charged into the kneaded material by using a brush, and kneading was continued for 1 minute. After that, the ram was raised again, and the powder of the mixture of zinc oxide, stearic acid and an anti-aging agent adhered to the surrounding was charged into the kneaded material by using a brush, and kneading was continued for 3 minutes, and the mixture was discharged.
(ii) Roll Kneading (Addition of Cross-linking System): After the temperature was sufficiently lowered upon discharge, a cross-linking agent was added to the kneaded material by two rolls, and the kneaded material was then kneaded to obtain an elastomer composition.

After that, the obtained elastomer composition was placed in a mold (50 mm×50 mm×130 μm) and heated and pressurized at 170° C. for 20 minutes to obtain an actuator member having a thickness of 130 μm.
Rubber (EPDM, ethylene content: 65% by mass, diene content: 4.6% by mass, Product name: 3092 PM, manufactured by Mitsui Chemicals)
   100 parts by mass
Peroxide-based cross-linking agent (dicumyl peroxide (DCP), manufactured by NOF Corporation)
   7 parts by mass
Zinc oxide (manufactured by Hakusui Tech, Product name: zinc oxide type 3)
   5 parts by mass
Stearic acid (manufactured by Nippon Fine Chemical Co., Ltd.; Product name: stearic acid)
   1 part by mass
Anti-aging agent (manufactured by Ouchi Shinko Chemical Industrial; Product name: NOCCRAC 224)
   0.5 parts by mass

### Example 2

An elastomer composition and an actuator member were obtained in the same manner as in Example 1 except that 14 parts by mass of a peroxide-based cross-linking agent (DCP) was added.

### Example 3

An elastomer composition and an actuator member were obtained in the same manner as in Example 1 except that 5 parts by mass of a cross-linking aid (TRIC, manufactured by Mitsubishi Chemical Corporation) was added simultaneously with the addition of a peroxide-based cross-linking agent (DCP).

### Comparative Example 1

An elastomer composition and an actuator member were obtained in the same manner as in Example 1 except that 2 parts by mass of a peroxide-based cross-linking agent (DCP) was added.

### Example 4

An elastomer composition and an actuator member were obtained in the same manner as in Example 1 except that a sulfur-based cross-linking agent and a cross-linking accelerator were added in the following amounts in place of the peroxide-based cross-linking agent.
Sulfur-based crosslinking agent (oil-treated sulfur; manufactured by Hosoi Chemical Co., Ltd.; Product name: HK200-5)
   1 part by mass
Cross-linking accelerator (manufactured by Ouchi Shinko Chemical Industrial, Product name: NOCCELER TOTN)
   2 parts by mass
Cross-linking accelerator (manufactured by Ouchi Shinko Chemical Industrial; Product name: NOCCELER ZTC)
   0.5 parts by mass
Cross-linking accelerator (manufactured by Ouchi Shinko Chemical Industrial; product name: NOCCELER CZ)
   1.5 parts by mass

### Example 5

An elastomer composition and an actuator member were obtained in the same manner as in Example 4 except that the addition amounts of the sulfur-based cross-linking agent and each cross-linking accelerator were changed to twice the amount.

### Comparative Example 2

An elastomer composition and an actuator member were obtained in the same manner as in Example 4 except that the addition amounts of the sulfur-based cross-linking agent and each cross-linking accelerator were changed to half of the amount.

### Comparative Example 3

An elastomer composition and an actuator member were obtained in the same manner as in Example 1 except that 100 parts by mass of a rubber (SBR, product name: 1502, manufactured by Nippon Zeon Co., Ltd.) was added in place of the rubber (EPDM) and 1 part by mass of an anti-aging agent (NOCCRAC 6C) was added in place of the anti-aging agent (NOCCRAC 224).

### [Physical Property Evaluation]

Physical properties of the elastomer compositions and actuator members obtained in Examples 1 to 5 and Comparative Examples 1 to 3 were evaluated by the following method.

### [Thermal Mechanical Analysis (TMA)]

Stress of the elastomer composition was measured using a thermal mechanical analysis device (model number: TMA/SS6200 manufactured by Hitachi High-Tech Science Co., Ltd.) under the following conditions. A sample used for the measurement was prepared by pressing the above-mentioned actuator member against the cutting edge of a cutter so that the length was 20 mm and the width was 1 mm, and then cutting the actuator member at once by hitting the actuator member with a hammer from above. The sample thus prepared was sandwiched between chucks so that the distance between the chucks was 10 mm and was then set in the device. The length, width and distance between the chucks of the sample were measured using a tool microscope (model number: TM-500, manufactured by Mitutoyo Corporation).
Heating rate: 2° C./min.
Sampling time: 1 s
Temperature range: 20° C. to 110° C.
Tensile distortion: 50%

### [Entropy Elastic Modulus]

The entropy elastic modulus of an elastomer composition was calculated by the following formula, and the results are shown in Table 1.

The tensile force F when the elastomer composition is elongated is expressed by a Kelvin equation, where the first term represents energy elasticity (f_{U}) due to internal energy and the second term represents the entropy elasticity (f_{S}) due to entropy. That is, the entropy elasticity depends on temperature (T), and the gradient (∂F/∂T) is an important parameter as the entropy elastic modulus.

$$F = {( \frac{\partial U}{\partial L} )}_{p , T} - {T ( \frac{\partial S}{\partial L} )}_{p , T} = {( \frac{\partial U}{\partial L} )}_{p , T} + {T ( \frac{\partial F}{\partial T} )}_{p , L}$$

In the elongated state, the stress of the elastomer composition increases with increasing temperature, and the appearance of the entropy elasticity can be confirmed. The gradient at this time becomes the entropy elastic modulus. This gradient was calculated using Excel and used as the entropy elastic modulus.

### [Manufacturing of Actuator Element]

(Preparation of PEDOT: PSS-PG (n=4) Solution)

An aqueous dispersion of poly(3,4-ethylenedioxythiophene):poly(4-styrenesulfonate) (PEDOT:PSS) (pH=7, neutralizer:ammonia) and polyglycerin (PG, n=4, molecular weight: 310, Sakamoto Yakuhin Kogyo Co., Ltd.) were mixed at a ratio of 4:6 and adjusted so that the solid component concentration was 2% by mass. Thereafter, the mixture was sufficiently stirred with a magnetic stirrer.

### (Preparation of Conductive Polymer Film)

The surface of a 52×76 mm slide glass was washed with ethanol and 12.0 g of the prepared PEDOT: PSS-PG solution was added dropwise thereto. This was heated and dried in air at 160° C. for 1 hour using a moisture meter (Moisture Balance MOC-120H, manufactured by Shimadzu Corporation). Finally, the film was peeled off from the glass substrate using a tweezer to obtain a conductive polymer film having a thickness of about 50 μm.

### (Production of ETP Actuator Element)

First, the actuator member was cut into a 5 mm×20 mm piece. Next, a polymer film having a thickness of about 50 μm produced as described above was cut into a 5 mm×20 mm piece (the top and bottom portions are left at 5 mm each, and 10 mm in between was in the form of a mesh) using a three axis CO₂ laser marker (ML-Z 9550, KEYENCE) to obtain a film for a heater layer. Then, a heat conductive layer was formed by thinly applying a heat radiating material (G-775, heat conductive grease, manufactured by Shin-Etsu Chemical Co., Ltd.) on the actuator member, and a conductive polymer film produced as described above as a heater layer was laminated on the heat conductive layer to obtain an actuator element.

### (Measurement of Actuator Performance)

Using the obtained ETP actuator element (thickness 180 μm×width 5 mm×length 20 mm), the contraction rate of the actuator member was measured under the following conditions. The upper and lower ends of the actuator element were clipped with metal clips, and a constant load was suspended. As a result, the actuator member was elongated by 100%. When it was sandwiched in a chuck, platinum foil was sandwiched in between so that it was brought into sufficient contact. Direct current voltage was applied to both ends of the actuator element using a direct current power supply (REGULATED DC POWER SUPPLY, MSAZ36-1P1M3, manufactured by Nihon Stabilizer Kogyo Co., Ltd.) to apply heat energy to the actuator member. The contraction state of the actuator member at that time was photographed with a camera, the contraction amount was measured by image analysis, and the contraction rate was calculated. The contraction rate is a ratio of the contraction amount with respect to the length (length at elongation) in a state where the actuator member is elongated by 100% by applying a constant load to the actuator member (contraction amount/length at elongation). The calculation results of the contraction rate are shown in Table 1.

### [Measurement Conditions]

Load: 88 to 140 g
Elongation due to load: 100%
Measurement temperature: 25 to 50° C.
Monitoring items: voltage (V), current (mA)
Sampling time: 100 ms

The work density of the actuator member was determined by the following formula. The calculation results of the work density are shown in Table 1. The work density in Test Example 1 is preferably 180 kJ/m³ or more, more preferably 190 kJ/m³ or more, and further preferably 200 kJ/m³ or more.

### Formula 3:

$$W = \frac{mgh}{{V}_{ETP}}$$

W: work density (J/m³)
m: load (kg)
g: acceleration due to gravity (9.8 m/s²)
h: contraction amount (m)
V_{ETP}: volume of the ETP actuator member (m³)

TABLE 1

| | | Comp. | | | | Comp. | | | Comp. |
|---|---|---|---|---|---|---|---|---|---|
| | | Ex. 1 | Ex. 1 | Ex. 2 | Ex. 3 | Ex. 2 | Ex. 4 | Ex. 5 | Ex. 3 |
| Elastomer | Rubber (EPDM) | 100 | 100 | 100 | 100 | 100 | 100 | 100 | 0 |
| Composition | Rubber (SBR) | 0 | 0 | 0 | 0 | 0 | 0 | 0 | 100 |
| | Peroxide-based | 2 | 7 | 14 | 7 | 0 | 0 | 0 | 7 |
| | cross-linking agent | | | | | | | | |
| | Sulfur-based | 0 | 0 | 0 | 0 | 0.5 | 1 | 2 | 0 |
| | cross-linking agent | | | | | | | | |
| | Cross-linking | 0 | 0 | 0 | 0 | 1 | 2 | 4 | 0 |
| | Accelerator | | | | | | | | |
| | (NOCCELER TOTN) | | | | | | | | |
| | Cross-linking | 0 | 0 | 0 | 0 | 0.25 | 0.5 | 1 | 0 |
| | Accelerator | | | | | | | | |
| | (NOCCELER ZTC) | | | | | | | | |
| | Cross-linking | 0 | 0 | 0 | 0 | 0.75 | 1.5 | 3 | 0 |
| | Accelerator | | | | | | | | |
| | (NOCCELER CZ) | | | | | | | | |
| | Cross-linking aid | 0 | 0 | 0 | 5 | 0 | 0 | 0 | 0 |
| | (TAIC) | | | | | | | | |
| | Zinc Oxide | 5 | 5 | 5 | 5 | 5 | 5 | 5 | 5 |
| | Stearic acid | 1 | 1 | 1 | 1 | 1 | 1 | 1 | 1 |
| | Anti-aging agent | 0.5 | 0.5 | 0.5 | 0.5 | 0.5 | 0.5 | 0.5 | 0 |
| | (NOCCRAC 224) | | | | | | | | |
| | Anti-aging agent | 0 | 0 | 0 | 0 | 0 | 0 | 0 | 1 |
| | (NOCCRAC 6C) | | | | | | | | |
| Entropy Elastic Modulus (kPa/K) | | 2.5 | 4.9 | 7.3 | 7.6 | 1.8 | 3.3 | 5.9 | 2.9 |
| Measurement | Contraction rate (%) | 2.6 | 10.0 | 12.8 | 8.4 | 7.9 | 13.0 | 10.5 | 2.0 |
| Results | Work density | 56 | 213 | 324 | 298 | 160 | 252 | 239 | 46 |
| | (kJ/m³) | | | | | | | | |

When Examples 1 to 3 and Comparative Example 1 using the peroxide-based cross-linking agent were compared, Examples 1 to 3 having an entropy elastic modulus of 3.0 kPa/K or more (4.9 kPa/K, 7.3 kPa/K, 7.6 kPa/K) had higher actuator performance (work density) than Comparative Example 1 having an entropy elastic modulus of 2.5.

When Examples 4 and 5 and Comparative Example 2 using a sulfur-based cross-linking agent were compared, Examples 4 and 5 having an entropy elastic modulus of 3.0 kPa/K or more (3.3 kPa/K, 5.9 kPa/K) had a higher actuator performance (work density) than Comparative Example 2 having an entropy elastic modulus of 1.8.

When Example 1 and Comparative Example 3 using different types of rubbers were compared, Example 1 using a rubber (EPDM) containing an ethylene-derived structural unit had higher actuator performance (work density) than Comparative Example 3 using a rubber (SBR) containing no ethylene-derived structural unit.

Therefore, it was found that the actuator performance (work density) can be improved by using the elastomer composition for an actuator of the present invention.

### Test Example 2

### Example 6

The following components were kneaded using a 100 mL kneader (Laboplast Mill manufactured by Toyo Seiki Co., Ltd.) to obtain an elastomer composition. The details of the kneading operation are as shown in (i) to (ii) below.

(i) Mixer kneading: Rubber was charged into a closed pressure kneader heated to 120° C., and after mastication was performed at 30 rpm for 1 minute, half of the amount of a mixture measured of zinc oxide, stearic acid and an anti-aging agent was charged, and the rotational speed was raised to 50 rpm, and kneading was performed for 1 minute and 30 seconds. Then, the remaining half of the amount of the mixture of zinc oxide, stearic acid and an anti-aging agent was added, and kneading was continued for 1 minute and 30 seconds. After that, ram (floating weight) was raised, and the powder of the mixture of zinc oxide, stearic acid and an anti-aging agent adhered to the surrounding was charged into the kneaded material by using a brush, and kneading was continued for 1 minute. After that, the ram was raised again, and the powder of the mixture of zinc oxide, stearic acid and an anti-aging agent adhered to the surrounding was charged into the kneaded material by using a brush, and kneading was continued for 3 minutes, and the mixture was discharged.
(ii) Roll Kneading (Addition of Cross-linking System): After the temperature was sufficiently lowered by releasing heat, a cross-linking agent was added to the kneaded material by two rolls, and the kneaded material was then kneaded to obtain an elastomer composition.

After that, the obtained elastomer composition was placed in a mold (50 mm×50 mm×130 μm) and heated and pressurized at 170° C. for 20 minutes to obtain an actuator member having a thickness of 130 μm.
Rubber (EPDM, ethylene content: 45% by mass, diene content: 7.6% by mass, Product name: 4045 M, manufactured by Mitsui Chemicals)
   100 parts by mass
Peroxide-based cross-linking agent (dicumyl peroxide (DCP), manufactured by NOF Corporation)
   8 parts by mass
Zinc oxide (manufactured by Hakusui Tech, Product name: zinc oxide type 3)
   5 parts by mass
Stearic acid (manufactured by Nippon Fine Chemical Co., Ltd.; Product name: stearic acid)
   1 part by mass
Anti-aging agent (manufactured by Ouchi Shinko Chemical Industrial; Product name: NOCCRAC 224)
   0.5 parts by mass

### Example 7

An elastomer composition and an actuator member were obtained in the same manner as in Example 6 except that 100 parts by mass of rubber (EPDM, ethylene content: 65% by mass, diene content: 4.6% by mass, product name: 3092PM, manufactured by Mitsui Chemicals) was added in place of rubber (EPDM).

### Example 8

An elastomer composition and an actuator member were obtained in the same manner as in Example 6 except that 100 parts by mass of rubber (EPDM, ethylene content: 72% by mass, diene content: 3.6% by mass, product name: X-3012P, manufactured by Mitsui Chemicals) was added in place of rubber (EPDM).

### [Physical Property Evaluation]

Physical properties of the elastomer compositions and actuator members obtained in Examples 6 to 8 were evaluated by the following method.

### [Entropy Elastic Modulus]

The entropy elastic modulus of the elastomer compositions was calculated by the same method as in Test Example 1.

### (Measurement of Actuator Performance)

The actuator member was cut into a 5 mm×40 mm piece which was used as a test piece (130 μm in thickness×5 mm in width×40 mm in length). The test piece thus obtained was clipped with a double clip 3 mm each at the top and bottom, and 82 g of weight was hung on the bottom. Next, the test piece was heated to a temperature of 25° C. for 5 seconds by a dryer, and then allowed to cool for 15 seconds at room temperature (15° C.). This operation was repeated four times and the length (standard length) of the test piece after the fourth cooling was measured and then the length (contraction length) of the test piece after the fifth heating at 25° C. was measured. From the obtained standard length and contraction length, the contraction rate was calculated by the following formula. The calculation results of the contraction rate are shown in Table 2.

Contraction rate (%)=(standard length−contraction length)/standard length×100

Subsequently, the work density of the actuator member was calculated by the same method as in Test Example 1. The work density in Test Example 2 is preferably 50 kJ/m³ or more, more preferably 100 kJ/m³ or more, still more preferably 180 kJ/m³ or more, and further more preferably 200 kJ/m³ or more.

TABLE 2

| | | Ex. 6 | Ex. 7 | Ex. 8 |
|---|---|---|---|---|
| Elastomer | Rubber (EPDM: 4045M) | 100 | 0 | 0 |
| Composition | Rubber (EPDM: 3092PM) | 0 | 100 | 0 |
| | Rubber (EPDM: X-3012P) | 0 | 0 | 100 |
| | Peroxide-based cross- | 8 | 8 | 8 |
| | linking agent | | | |
| | Zinc oxide | 5 | 5 | 5 |
| | Stearic acid | 1 | 1 | 1 |
| | Anti-aging agent | 0.5 | 0.5 | 0.5 |
| | (NOCCRAC 224) | | | |
| Entropy Elastic Modulus (kPa/K) | | 3.1 | 5.2 | 5.8 |
| Measurement | Contraction rate (%) | 9.4 | 34.4 | 37.6 |
| Results | Work density (kJ/m³) | 67 | 212 | 232 |

In Examples 6 to 8, the actuator member using EPDM having an ethylene content of 45% by mass or more had a high contraction rate due to the change in the amount of heat energy. In particular, by adjusting the ethylene content of the EPDM to 50% by mass or more, the actuator member had a remarkably high contraction rate due to the change in the amount of heat energy, and the actuator performance (work density) was high.

### DESCRIPTION OF SYMBOLS

10 Actuator Element
11 Actuator Member
12 Heater Layer

1. An elastomer composition for use in an actuator that can be operated only by changing the amount of heat energy, wherein the elastomer composition for an actuator has an entropy elastic modulus of 3.0 kPa/K or more and comprises a polymer comprising at least a structural unit derived from ethylene.

2. The elastomer composition for an actuator according to claim 1, wherein the polymer is a synthetic rubber comprising at least a structural unit derived from ethylene.

3. The elastomer composition for an actuator according to claim 2, wherein the polymer is at least one selected from the group consisting of ethylene propylene rubber, ethylene butene rubber, ethylene octene rubber, ethylene propylene diene rubber, ethylene butene diene rubber, and ethylene octene diene rubber.

4. The elastomer composition for an actuator according to claim 1, wherein the ethylene content in the polymer is 45% by mass or more.

5. The elastomer composition for an actuator according to claim 1, wherein the polymer is cross-linked by using a cross-linking agent.

6. The elastomer composition for an actuator according to claim 5, wherein the cross-linking agent is a peroxide-based cross-linking agent or a sulfur-based cross-linking agent.

7. An actuator member formed of the elastomer composition for an actuator according to claim 1.

8. The actuator member according to claim 7, wherein the actuator member is in the form of a film, a sheet, a plate, or a rod.

9. An actuator element comprising the actuator member according to claim 7, and a heater layer.

10. The actuator element according to claim 9, wherein the heater layer is comprised of a heating element.

11. The actuator element according to claim 10, wherein the heating element is comprised of a resistant heating element using Joule heat.

12. The actuator element according to claim 9, wherein the actuator element further comprises a thermally conductive layer between the actuator member and the heater layer.

13. The actuator element according to claim 12, wherein the thermally conductive layer is comprised of a heat radiating material.

14. The elastomer composition for an actuator according to claim 3, wherein the ethylene content in the polymer is 45% by mass or more.

15. The elastomer composition for an actuator according to claim 14, wherein the polymer is cross-linked by using a cross-linking agent.

16. The elastomer composition for an actuator according to claim 15, wherein the cross-linking agent is a peroxide-based cross-linking agent or a sulfur-based cross-linking agent.

17. An actuator member formed of the elastomer composition for an actuator according to claim 16.

18. The actuator member according to claim 17, wherein the actuator member is in the form of a film, a sheet, a plate, or a rod.

19. An actuator element comprising the actuator member according to claim 18, and a heater layer.

20. The actuator element according to claim 19, wherein the actuator element further comprises a thermally conductive layer between the actuator member and the heater layer.
